(19) United States
(12) Patent Application Publication
(10) Pub. No.: US 2024/0227346 A1
(43) Pub. Date: Jul. 11, 2024

(54) Systems and Methods for Multilayer Forming of Continuous Fibers Around a Mandrel

(71) Applicant: FUTURE COMP LLC, Gunnison, UT (US)

(72) Inventors: Joseph Stanish, Gunnison, UT (US); Nicholas Przybysz, Gunnison, UT (US)

(21) Appl. No.: 18/410,940

(22) Filed: Jan. 11, 2024

Related U.S. Application Data
(60) Provisional application No. 63/479,534, filed on Jan. 11, 2023.

(51) Int. Cl. B32B 5/12; B29C 35/08; B29C 65/00; B29C 65/08; B29C 70/32; B29K 105/12; C08J 5/24

(52) U.S. Cl. CPC B32B 5/12; C08J 5/24; B29C 35/0805; B29C 2035/0822; B29C 65/08; B29C 66/72141; B29C 70/32; B29K 2105/12; B32B 2260/023; B32B 2260/046; B32B 2307/718

(57) ABSTRACT

A composite structure includes a polymer material, and axial fibers and radial fibers arranged within the polymer material. The composite structure includes a body and a sidewall that defines a cylindrical lumen. The sidewall has a consistent fiber to polymer distribution relative to the body.

### CROSS REFERENCE TO RELATED APPLICATIONS

This application claims the benefit of priority to U.S. Provisional Patent Application No. 63/479,534, filed 11 Jan. 2023, and entitled “SYSTEMS AND METHODS FOR MULTILAYER FORMING OF CONTINUOUS FIBERS AROUND A MANDREL,” the disclosure of which is hereby incorporated in its entirety for all purposes.

### FIELD

The described embodiments relate generally to fiber reinforced thermoplastic structures, and more particularly, to composite fiber reinforced thermoplastic materials formed to capture a mandrel.

### BACKGROUND

Composites are typically light and structurally strong. However, due to their formation and material distribution, complex shapes are often difficult to achieve, while maintaining the desirable mechanical properties. Particularly, composite structures that are heated to induce deformation often suffer from a redistribution of the structural elements that can have an undesirable effect on the end component. As such, the need continues for systems and techniques to facilitate formation of complex composite shapes without sacrificing the mechanical benefits achieved by the specific structural organization.

### SUMMARY

Examples of the present disclosure are directed to a composite structure, such as a leaf spring, that is formed of fiber reinforced thermoplastic materials, reoriented to form a substantially cylindrical portion configured to receive an axel or other component. The cylindrical portion forms a loop at the end of the leaf spring structure to accommodate mounting hardware, an axel, or other elements.

In some examples, a composite structure, can include a polymer material and both axial fibers and radial fibers arranged within the polymer material. In an example, the composite structure can include a body and a sidewall that defines a cylindrical lumen. In at least one example, the sidewall includes a consistent fiber to polymer distribution relative to the body.

In some examples, the polymer material can include at least one of a thermoplastic material or a thermoset material. The thermoplastic material can include a resin matrix having at least one of Polyamide 6, Nylon 6, polycaprolactam (PA6), Polyphenylene sulfide (PPS), Polyetherimide (PEI), Polyetheretherketone (PEEK), polyamide (PA12), nylon (PA11), or Polyethylene terephthalate (PET). In some examples, the thermoset material can include at least one of an epoxy, silicone, polyurethane, or phenolic.

In at least one example, the cylindrical lumen can include a diameter between about 0.3 cm and about 1.3 cm. In an example, the composite structure can include a fiber areal weight between about 80 gsm and about 250 gsm.

In some examples, a fiber reinforced polymer structure can include a thermoplastic or thermoset material and axial fibers and radial fibers arranged within the thermoplastic or thermoset material. In an example, the polymer structure includes a body and a sidewall that defines a cylindrical lumen. The axial fibers and radial fibers can be arranged in a predetermined pattern. In some examples, the predetermined pattern can include one of a spiral pattern, a twist, or a weave. In some examples, the polymer structure exhibits a damping coefficient greater than about 87.5 N s/m. In at least one example, polymer structure can include a cylindrical portion configured to receive at least one of an axel or a mounting hardware.

In at least one example, a method for forming a composite structure can include stacking a plurality of plies of fiber-reinforce laminate and ultrasonically tacking a first portion of the laminate plies together. In an example, the method further includes slip forming a second portion of the laminate plies around a mandrel and back onto the first portion. In some examples, the method also includes applying infrared to the second portion of the laminate plies to form a semi-consolidated blank and then consolidating the first and second portion.

In some examples, the plurality of plies of fiber-reinforce laminate can include between about 10 and about 25 layers of fiber-reinforce laminate. In some examples, the first portion of the laminate plies can include between about 25% and about 75% of the plies ultrasonically tacked together. In at least one example, the laminate plies are ultrasonically tacked together by spot tacking at regular intervals to prevent relative movement of the laminate plies. In an example, the first portion of the laminate plies are ultrasonically tacked in a mandrel fixture.

In some examples, consolidating the first and second portion can include loading the semi-consolidated blank into a compression tool. In an example, the compression tool can include a frame including a top portion and a bottom portion, wherein the semi-consolidated blank is held within the frame while consolidating the first and second portion. In some examples, consolidating the first and second portion can include applying pressure and heat to the semi-consolidated blank. In some examples, the heat applied results in a temperature including between about 120° C. and about 400° C. In some examples, applying pressure can include applying a pressure between about 20 bar and about 2070 bar.

In addition to the exemplary aspects and embodiments described above, further aspects and embodiments will become apparent by reference to the drawings and by study of the following description.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 is a block flow diagram detailing a method for forming a composite structure, according to an embodiment.

FIG. 2 is a side view illustrating an application of infrared light energy to a composite structure, according to an embodiment.

FIG. 3 illustrates a consolidation structure used to maintain a shape of a composite piece during the application of heat and pressure, according to an embodiment.

FIG. 4 illustrates a consolidation structure used to maintain a shape of a composite piece during the application of heat and pressure, according to an embodiment.

FIG. 5 illustrates a consolidation structure used to maintain a shape of a composite piece during the application of heat and pressure, according to an embodiment.

### DETAILED DESCRIPTION

The description that follows includes sample systems, methods, and apparatuses that embody various elements of the present disclosure. However, it should be understood that the described disclosure can be practiced in a variety of forms in addition to those described herein.

The following disclosure relates generally to systems and methods for forming composite structures configured to be reshaped to securely capture and/or house another element. For example, a leaf spring is preferably formed with a cylindrically shaped end that can receive hardware and other mounting fasteners. However, when forming such a shape with composites, a monolithic piece is typically formed and then re-heated to a plastic state and re-shaped around a mandrel or other element to form the desired shape. When reheated to a plastic state and bent around the mandrel, traditional materials are placed under tension and the structural fibers within the plasticized resin shift inward toward the mandrel. After formation, the resulting cylindrical element is then structurally compromised because the fundamental structure of the composite has changed. Additionally, such a method results in a product that is not consistently repeatable.

In contrast, the present systems and methods maintain the distribution of the structural elements relative to the polymer while forming the desired cylindrical feature that can be used to capture a fastening element, an axel, or other structural or cosmetic element. This process results in a repeatable method that maintains the desired fiber to matrix distribution and provides consistent mechanical properties.

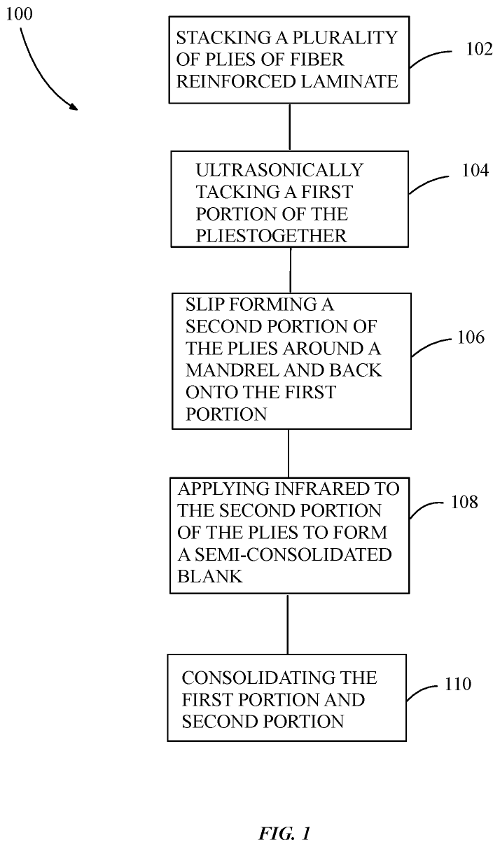

An example method for forming the cylindrical element on the end of a thermoplastic composite element is provided in FIG. 1. Specifically, FIG. 1 illustrates a method 100 for forming a composite structure. According to one example, the method 100 can be performed with unconsolidated laminate sheets, each sheet including structural fibers (such as uni-directional carbon or fiberglass fibers) in a thermoplastic resin or a thermoset polymer. In designing the desired structure, the orientation, layup, and distribution of the structural fibers can be considered. According to one example, about 10-25 layers of the laminate sheets can be used, though the present exemplary systems and methods can be performed with any number of layers.

In some examples, the method 100 includes an act 102 of stacking a number of plies of fiber-reinforce laminate. Laminates are made of plies, in which all fibers often have the same direction. The fibers are usually much stronger and stiffer than the matrix so a ply is stiffer and stronger in the fiber direction—it is anisotropic. In some examples, the plies are stacked manually. In other examples, the plies are stacked with machinery and are stacked according to a predetermined number of layers.

In some examples, the method 100 includes an act 104 of ultrasonically tacking a first portion of the laminate plies together. In an example, the plies can be tacked together in a mandrel fixture. In some examples, the first portion of the laminate plies can include between about 25% and about 75% of the plies ultrasonically tacked together. According to one example, about 45% of the unconsolidated laminate lengths are ultrasonically tacked, which tacking can occur in the mandrel fixture. The remaining about 55% of the laminate lengths can be included as a second portion and are allowed to slip form around a mandrel or other cylindrical forming element. In other words, the method 100 includes an act 106 of slip forming a second portion of the laminate plies around a mandrel and back onto the first portion. When formed, each layer is allowed to grow in diameter over the mandrel or cylindrical element to form the desired cylinder.

In an example, the method 100 includes an act 108 of applying infrared to the second portion of the laminate plies to form a semi-consolidated blank. A focal infrared source is directed on the untacked and unconsolidated laminate, to slip form the laminate substantially 180 degrees around a fixed cylindrical element of a desired diameter. The infrared source allows for consolidation around the mandrel by the non-tacked laminate, while the ultrasonically welded layers are kept in place. In some examples, the un-tacked layers are folded back over the mandrel and back on top of the selectively tacked layers.

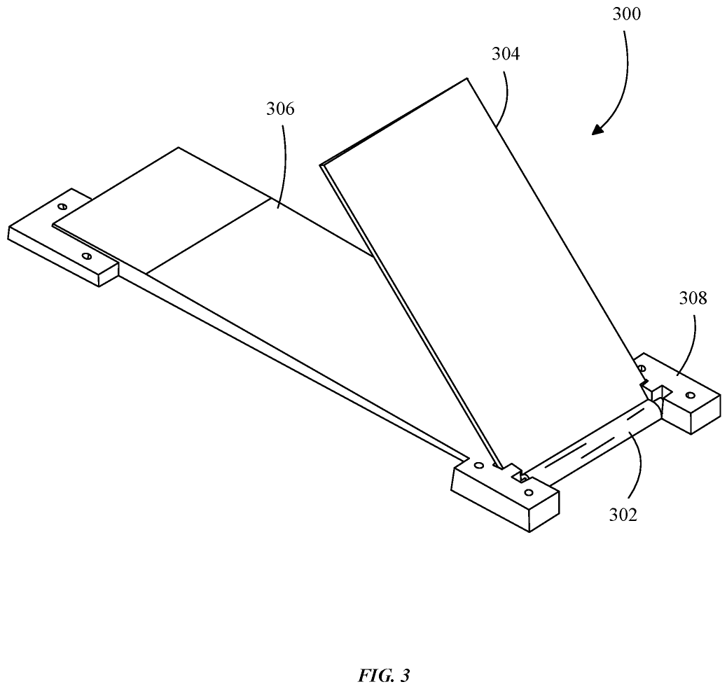

In some examples, the method 100 further includes an act 110 of consolidating the first and second portion for a final consolidation step. In other words, once formed around the mandrel, the semi-consolidated blank folded over the mandrel is loaded into a compression tool. In some examples, consolidating the first and second portion comprises loading the semi-consolidated blank into a compression tool. In at least one example, the compression tool can include a frame including a top portion and a bottom portion. In an example, the semi-consolidated blank is held within the frame while consolidating the first and second portion described further below in reference to FIGS. 3-5.

The act 110 can include applying pressure and heat to the semi-consolidated blank. In at least one example the heat applied can result in a temperature that includes between about 120° C. and about 400° C. In some examples, the temperature range can include a temperature less than about 400° C. In other examples, the temperature can be less than 300° C., less than 250° C., or less than 150° C. In some examples the temperature at the final consolidation step can be in ranges between about 120° C. and about 180ºC. Other ranges can include between about 150° C. and about 250° C., between about 250° C. and about 300° ° C., between about 300° C. and about 350° C., or between about 350° C. and about 400° C.

In some examples, the pressure being applied to the semi-consolidated blank in act 110 can include applying a pressure between about 20 bar and about 2070 bar. In some examples, the pressure range can include a pressure less than about 2070 bar. In other examples, the pressure can be less than 1000 bar, less than 500 bar, or less than 100 bar. In some examples the pressure at the final consolidation step can be in ranges between about 20 bar and about 150 bar. Other ranges can include between about 150 bar and about 300 bar, between about 300 bar and about 800 bar, between about 800 bar and about 1200 bar, between about 1200 bar and about 1800 bar, or between about 1800 bar and about 2100 bar.

After the application of pressure and heat, the consolidated piece is removed from the compression tool and the mandrel is removed from the consolidated piece, leaving continuous fiber wrapped around the final diameter. This process allows for wrap around the mandrel without undue slipping or reorientation of the laminate layers.

An exemplary method for forming a composite structure including a substantially cylindrical portion to receive an axel or mounting hardware includes stacking a number of plies of fiber-reinforce laminate. According to one example, the present method is performed with unconsolidated laminate sheets, each sheet including structural fibers. In some examples, the composite structure can include a polymer material. In at least one example, the polymer material can include at least one of a thermoplastic material or a thermoset material.

A thermoplastic is any plastic material which melts into a soft, pliable form above a certain temperature and solidifies upon cooling. Thermoplastics can be re-melted and re-shaped any number of times. In some examples, the composite structure can include a thermoplastic resin. In designing the desired structure, the orientation, layup, and distribution of the structural fibers and thermoplastic resin is considered. According to one example, about 11-25 layers of the laminate sheets are used, though the present exemplary systems and methods can be performed with any number of layers. Additionally, the present exemplary system can be performed with any number of materials. According to one example, the present method can be performed with fiberglass and/or carbon fibers with a thermoplastic resin, such as PEI resin. The structural fibers can be fiberglass, carbon fibers, e-glass, twisted glass, and the like. Similarly, the resin matrix can include any thermoplastic material including, but in no way limited to, Polyamide 6, Nylon 6, or polycaprolactam (PA6), Polyphenylene sulfide (PPS), Polyetherimide (PEI), Polyetheretherketone (PEEK), polyamide (PA12), nylon (PA11), Polyethylene terephthalate (PET), and the like.

In some examples, the composite structure can include a thermoset material. In contrast to thermoplastics, thermosets (alternately known as thermosetting plastics or thermosetting polymers) are materials which remain in a permanent solid state after being cured one time. Polymers within the material cross-link during the curing process to perform an unbreakable, irreversible bond. As such, thermosets will not melt even when exposed to extremely high temperatures. In some examples, the thermoset material can include at least one of an epoxy, silicone, polyurethane, or phenolic.

In some examples, the structural fibers can include uni-directional carbon or fiberglass fibers. In an example, the axial fibers and radial fibers arranged within the polymer material. According to one embodiment, the laminate sheets can be precisely stacked and placed prior to consolidation, to provide the desired fiber areal weight and orientation. In some examples, the fiber areal weight can include a range between about 80 grams per square meter (gsm) and about 250 gsm. In some examples, the fiber areal weight range can include a fiber areal weight less than about 250 gsm. In other examples, the fiber areal weight can be less than 200 gsm, less than 150 gsm, or less than 100 gsm. In some examples the fiber areal weight of the composite structure can be in ranges between about 80 gsm and about 100 gsm. Other ranges can include between about 100 gsm and about 125 gsm, between about 125 gsm and about 150 gsm, between about 150 gsm and about 200 gsm, between about 200 gsm and about 225 gsm, or between about 225 gsm and about 250 gsm.

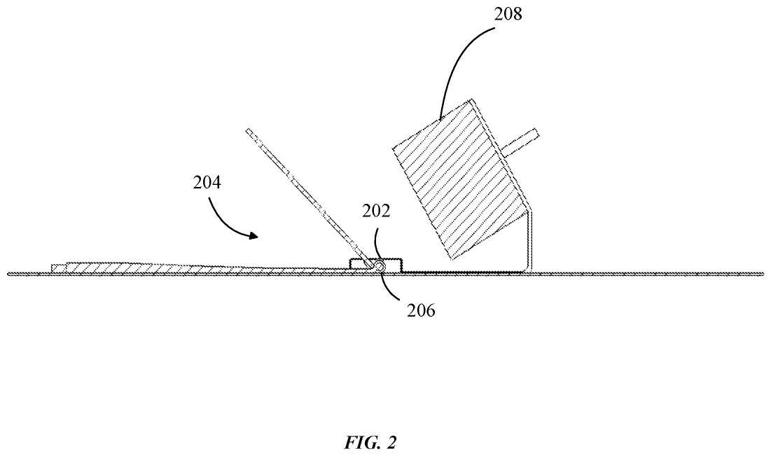

Once stacked, the present exemplary method then ultrasonically tacks the laminate. FIG. 2 illustrates an example local application of infrared energy to the unconsolidated laminate, allowing it to slip form around the mandrel. In some examples, the laminate 202 can be tacked in a mandrel fixture 204. According to one example, about 45% of the unconsolidated laminate lengths are ultrasonically tacked, which tacking can occur in the mandrel fixture. Ultrasonic welding or tacking includes high-frequency ultrasonic acoustic vibrations are locally applied to the laminate 202 being held together under pressure to create a solid-state weld. In ultrasonic welding, there are no connective bolts, nails, soldering materials, or adhesives necessary to bind the materials together. The ultrasonic energy combines the point contact between the parts, creating a joint 206. Ultrasonic welding of thermoplastics causes local combination of the plastic due to absorption of vibrational energy along the joint to be welded.

The ultrasonic tacking source includes an energy source 208 that can convert a high-frequency electrical energy into a high-frequency mechanical motion. The mechanical motion, along with applied force, creates frictional heat at the polymer materials' mating surfaces and/or joint area so the polymer material forms a molecular bond between the parts.

According to one embodiment, at least 25% of the unconsolidated laminate lengths are ultrasonically tacked. According to another exemplary embodiment, between 25 and 75% of the length of the unconsolidated laminate lengths are ultrasonically tacked. According to yet another exemplary embodiment, about 45-55% of the unconsolidated laminate lengths are ultrasonically tacked. According to one exemplary embodiment, the lengths are spot tacked at regular intervals to tie the laminate lengths together and to prevent relative movement of those portions of the laminate sheets. The infrared source allows for consolidation around the mandrel by the non-tacked laminate, while the ultrasonically welded layers are kept in place. The un-tacked layers are folded back over the mandrel and back on top of the selectively tacked layers. According to one embodiment, the fibers can form a braid around the mandrel, which further strengthens the final piece and prevents splitting around the resulting orifice.

In other embodiments a single continuous weld can be formed between two or more of the laminate sheets. According to one embodiment, the ultrasonic ranges are as follows in Table 1:

TABLE 1
Ultrasonic Ranges

| | 80% ampere | 90% ampere |
|---|---|---|
| Ply 1 | — | — |
| Ply 2 | 185 ms | 165 ms |
| Ply 3 | 195 ms | 175 ms |
| Ply 4 | 205 ms | 185 ms |
| Ply 5 | 240 ms | 230 ms |
| Ply 6 | 290 ms | 280 ms |
| Ply 7 | 330 ms | 320 ms |
| Ply 8 | 380 ms | 370 ms |
| Ply 9 | 460 ms | 450 ms |

The remaining untacked portions, about 55% in some embodiments, of the laminate lengths are allowed to slip form around a mandrel or other cylindrical forming element. When formed, each layer is allowed to grow in diameter over the mandrel or cylindrical element to form the desired cylindrical lumen. According to one exemplary embodiment, a focal infrared source is then directed on the untacked and unconsolidated laminate, to slip form the laminate substantially 180 degrees around a fixed cylindrical element of a desired diameter.

In some examples, the diameter of the cylindrical lumen include a range between about 0.3 cm and about 1.3 cm. In some examples, the diameter range can include a diameter less than about 1.5 cm. In other examples, the fiber areal weight can be less than 1 cm, less than 0.8 cm, or less than 0.5 cm. In some examples the diameter of the cylindrical lumen can be in ranges between about 0.3 cm and about 0.5 cm. Other ranges can include between about 0.5 cm and about 0.8 cm, between about 0.8 cm and about 1 cm, between about 1 cm and about 1.1 cm, between about 1.1 cm and about 1.2 cm, or between about 1.2 cm and about 1.3 cm.

Application of the infrared source can be localized and directed to limit the amount of consolidation that takes place and without reaching the melting point of the matrix such that the fiber to matrix balance is maintained.

Once formed around the mandrel, the semi-consolidated blank folded over the mandrel is loaded into a compression tool for a final consolidation step. In an example, the composite structure includes a body and a sidewall that defines a cylindrical lumen, wherein the sidewall includes a consistent fiber to polymer distribution relative to the body.

FIG. 3 illustrates an exemplary compression tool 300 that can be used to maintain the shape of the semi-consolidated blank as it is fully consolidated. The semi-consolidated piece 302 is secured for the application of heat and pressure, thereby allowing for full consolidation of the piece. As shown, the semi-consolidated piece 302 is formed substantially to its final shape and then loaded into the compression tool 300. In at least one example, the compression tool 300 can be a two-piece tool that maintains the shape and structure of the resulting piece. In some examples, the piece includes a top piece 304 and a bottom piece 306 that gets sandwiched in a frame 308 to hold the semi-consolidated piece 302 in place during the application of heat and full consolidation.

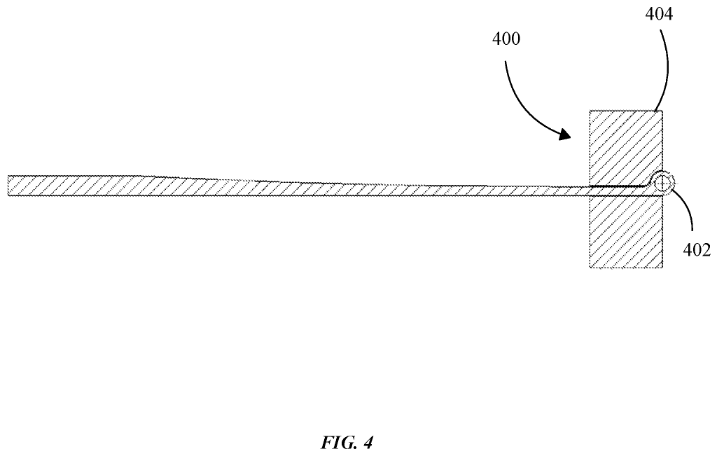

FIG. 4 shows the semi-consolidated piece 402 is secured for the application of heat and pressure in a compression tool 400. As shown, the semi-consolidated piece 402 is sandwiched in the frame 404 to hold the semi-consolidated piece 402 in place. In at least one example the heat applied can result in a temperature that includes between about 120° C. and about 400° C. The pressure being applied to the semi-consolidated blank in act 100 can include applying a pressure between about 20 bar and about 2070 bar, depending on the application.

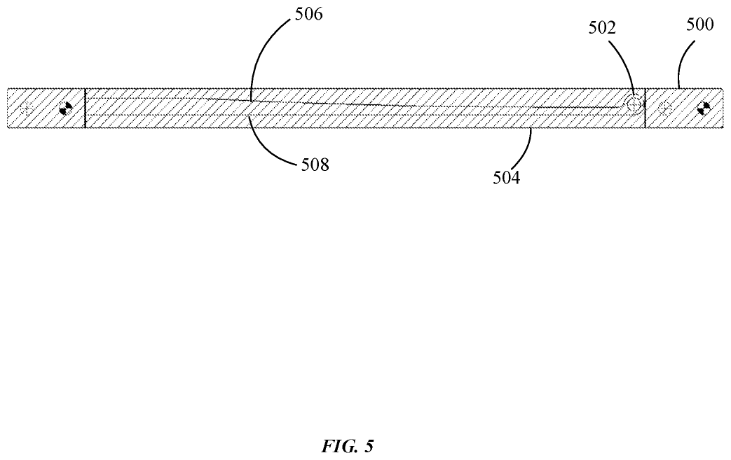

FIG. 5 shows the semi-consolidated piece 502 is secured for the application of heat and pressure in a compression tool 500. As shown, the semi-consolidated piece 502 is sandwiched in the frame 504 to hold the semi-consolidated piece 502 in place. As noted above, in some examples, the piece includes a top piece 506 and a bottom piece 508 that is sandwiched in a frame 504 to hold the semi-consolidated piece 502 in place during the application of heat and full consolidation.

After the application of pressure and heat, the consolidated piece is removed from the compression tool and the mandrel is removed from the consolidated piece, leaving continuous fiber wrapped around the final diameter. This process allows for wrap around the mandrel without undue slipping or reorientation of the laminate layers.

According to one embodiment, the resulting piece can include a fiber reinforced polymer structure. In an example, the polymer structure can include fibers of almost any desired orientation. In an example, the polymer structure includes a body and a sidewall that defines a cylindrical lumen, wherein the axial fibers and radial fibers are arranged in a predetermined pattern, such as defining a spiral pattern, twist or weave, and can be combined or otherwise associated with reinforcement fibers extending in the radial or axial direction of the mandrel. Additionally, in some examples, the use of a thermoplastic matrix enhances the damping characteristics of the resulting composite structure formed.

These enhanced damping characteristics can reduce the distribution of vibrations and/or shock through the composite structure. For example, the composite structures can be configured to exhibit a damping coefficient of greater than about 0.5 lbf s/in (87.5 N s/m). In some examples, the damping coefficient can be greater than about 90 N s/m, greater than 100 N s/m, or greater than 110 N s/m. In some examples the damping coefficient can be in ranges between about 85 N s/m and about 110 N s/m. Other ranges can include between about 85 N s/m and about 90 N s/m, between about 90 N s/m and about 100 N s/m, between about 100 N s/m and about 105 N s/m, or between about 105 N s/m and about 110 N s/m.

Damping restrains vibratory motion, such as mechanical oscillations and noise by dissipation of energy. Critical damping prevents vibration or is just sufficient to allow the object to return to its rest position in the shortest period of time. The automobile shock absorber is an example of a critically damped device.

Additionally or alternatively, the composite structures disclosed herein can be configured to limit vibrations to a value of less than about 5.0 m/s². In this regard, the composite structures can satisfy the ISO 5349-1:2001 standard for safe levels of damping. The composite structures can also satisfy other ISO standards associated with mechanical damping.

The resulting structure is a repeatable structure that can deflect and store energy, while facilitating attachment points and connection to a number of mechanical elements including, but in no way limited to, bolts or other fasteners, or an axel. In some examples, the polymer structure can include a cylindrical portion configured to receive at least one of an axel or a mounting hardware.

In some examples, the present system and method can be used to form a cylindrical eyelet on any number of fiber reinforced thermoplastic structures, such as leaf springs, dampeners, bow limbs for compound bows, actuation arms, and the like.

Other examples and implementations are within the scope and spirit of the disclosure and appended claims. For example, features implementing functions can also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and Band C). Further, the term “exemplary” does not mean that the described example is preferred or better than other examples.

The foregoing description, for purposes of explanation, uses specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings. While various aspects and embodiments have been disclosed herein, other aspects and embodiments are contemplated. The various aspects and embodiments disclosed herein are for purposes of illustration and are not intended to be limiting.

Terms of degree (e.g., “about,” “substantially,” “generally,” etc.) indicate structurally or functionally insignificant variations. In an example, when the term of degree is included with a term indicating quantity, the term of degree is interpreted to mean ±10%, ±5%, or ±2% of the term indicating quantity. Further, the terms “less than,” “or less,” “greater than,” “more than,” or “or more” include, as an endpoint, the value that is modified by the terms “less than,” “or less,” “greater than,” “more than,” or “or more.” In an example, when the term of degree is used to modify a shape, the term of degree indicates that the shape being modified by the term of degree has the appearance of the disclosed shape. For instance, the term of degree may be used to indicate that the shape may have rounded corners instead of sharp corners, curved edges instead of straight edges, one or more protrusions extending therefrom, is oblong, is the same as the disclosed shape, etc.

What is claimed is:

1. A composite structure, comprising:
a polymer material; and
axial fibers and radial fibers arranged within the polymer material;
wherein the composite structure includes a body and a sidewall that defines a cylindrical lumen, wherein the sidewall includes a consistent fiber to polymer distribution relative to the body.

2. The composite structure of claim 1, wherein the polymer material comprises at least one of a thermoplastic material or a thermoset material.

3. The composite structure of claim 2, wherein the thermoplastic material comprises a resin matrix including at least one of Polyamide 6, Nylon 6, polycaprolactam (PA6), Polyphenylene sulfide (PPS), Polyetherimide (PEI), Polyetheretherketone (PEEK), polyamide (PA12), nylon (PA11), or Polyethylene terephthalate (PET).

4. The composite structure of claim 2, wherein the thermoset material comprises at least one of an epoxy, a silicone, a polyurethane, or a phenolic.

5. The composite structure of claim 1, wherein the cylindrical lumen comprises a diameter between about 0.3 cm and about 1.3 cm.

6. The composite structure of claim 1, wherein the composite structure comprises a fiber areal weight between about 80 gsm and about 250 gsm.

7. A fiber reinforced polymer structure, comprising:
a thermoplastic or thermoset material; and
axial fibers and radial fibers arranged within the thermoplastic or thermoset material;
wherein the polymer structure includes a body and a sidewall that defines a cylindrical lumen; and
wherein the axial fibers and the radial fibers are arranged in a predetermined pattern.

8. The fiber reinforced polymer structure of claim 7, wherein the predetermined pattern comprises one of a spiral pattern, a twist, or a weave.

9. The fiber reinforced polymer structure of claim 7, wherein the polymer structure exhibits a damping coefficient greater than about 87.5 N s/m.

10. The fiber reinforced polymer structure of claim 7, wherein the polymer structure comprises a cylindrical portion configured to receive at least one of an axel or a mounting hardware.

11. A method for forming a composite structure, comprising:
stacking a plurality of plies of fiber-reinforce laminate;
ultrasonically tacking a first portion of the plies together;
slip forming a second portion of the plies around a mandrel and back onto the first portion;
applying infrared to the second portion of the plies to form a semi-consolidated blank; and
consolidating the first portion of the plies and the second portion of the plies.

12. The method of claim 11, wherein the plurality of plies of fiber-reinforce laminate comprises between about 10 and about 25 layers of fiber-reinforce laminate.

13. The method of claim 11, wherein the first portion of the plies comprises between about 25% and about 75% of the plies ultrasonically tacked together.

14. The method of claim 13, wherein the laminate plies are ultrasonically tacked together by spot tacking at regular intervals to prevent relative movement of the laminate plies.

15. The method of claim 11, wherein the first portion of the laminate plies are ultrasonically tacked in a mandrel fixture.

16. The method of claim 11, wherein consolidating the first and second portion comprises loading the semi-consolidated blank into a compression tool.

17. The method of claim 16, wherein the compression tool comprises a frame including a top portion and a bottom portion, wherein the semi-consolidated blank is held within the frame while consolidating the first and second portion.

18. The method of claim 11, wherein consolidating the first and second portion comprises applying pressure and heat to the semi-consolidated blank.

19. The method of claim 18, wherein the heat applied results in a temperature comprising between about 120° C. and about 400° C.

20. The method of claim 18, wherein applying pressure comprises applying a pressure between about 20 bar and about 2070 bar.
